(19) United States
(12) Patent Application Publication
(10) Pub. No.: US 2009/0187829 A1
(43) Pub. Date: Jul. 23, 2009

(54) AGGREGATION AND VISUALIZATION OF REUSED SHARED LISTS

(75) Inventors: Elizabeth A. Brownholtz, Andover, MA (US); Joan M. DiMicco, Brookline, MA (US); Casey Dugan, Medford, MA (US); Werner Geyer, Boston, MA (US); David R. Millen, Boxford, MA (US); Michael Muller, Medford, MA (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 12/017,057

(22) Filed: Jan. 21, 2008

(51) Int. Cl. G06F 3/14; G06F 17/30

(52) U.S. Cl. 715/739; 707/7; 707/E17.107

(57) ABSTRACT

Embodiments of the present invention provide a method, system and computer program product for aggregating and visualizing reused shared lists. A method for aggregating and visualizing reused shared lists can include selecting an existing shared list, determining a topic for the selected shared list, receiving list items by rank for the determined topic, generating a new shared list with the determined topic and received list items, and storing the new shared list in association with the existing shared list. The method further can include providing a reused shared list view for all reused shared lists for a common topic. Finally, the method can include aggregating all reused shared lists for a common topic and providing a view of the aggregation with list items either for each rank for each reused shared list or in rank order for all reused shared lists for the common topic.

### BACKGROUND OF THE INVENTION

1. Field of the Invention

The present invention relates to the field of social networking and more particularly to shared lists for social networks.

2. Description of the Related Art

A social network refers to a social structure of nodes each associated with a different person or organization. The interconnections of each node reflect direct relationships between the respective people and organizations such that the directness of a relationship between two persons or organizations associated with respective nodes can be summarized by the path of interconnections between the respective nodes. In this way, any one individual in a social network can evaluate the number and quality of social relationships with others in the network, those relationships ranging from close familial bonds to casual acquaintances.

The advent of the global Internet has changed the way in which social networks can be viewed. Originally, a mere visual tool describing a social phenomenon, computerized social networks facilitate the recognition and expansion of social networks amongst interacting users across the globe. Whereas geographic boundaries previously limited the extent and quality of a given social network, the global Internet enables limitless expansion of the social network based upon a vast set of aware collaborators coupled by the fabric of computer communications.

Commercial computerized social networks have become wildly popular in recent years—especially amongst the younger demographic. Examples include the MySpace™ computer socialized network maintained by MySpace, Inc. of Los Angeles, Calif., LinkedIn™ computerized business network maintained by LinkedIn Corporation of Palo Alto, Calif., and the Facebook™ computerized social network maintained by Facebook of Palo Alto, Calif. Commercial computerized social networks represent social networking services connecting users according to different types of interests in an aggregated view—generally a Web site hosting user contributed content through imagery and commentary.

Shared lists have become a staple of the commercial computerized social network. Shared lists are a content type created by users of a social network to express and share an opinion with other users in the social network. Specifically, shared lists generally include a rank ordering of items used to express likes or dislikes. Many Web sites today feature lists, including well known online booksellers and music distributors. While these lists allow basic sharing of items, it is difficult to aggregate lists about the same topic since lists are disconnected by nature. Consequently, when users inspired by the topic of an existing list intend to create a similar list, those users must manually create the new list from scratch.

### BRIEF SUMMARY OF THE INVENTION

Embodiments of the present invention address deficiencies of the art in respect to shared lists and provide a novel and non-obvious method, system and computer program product for aggregating and visualizing reused shared lists. In an embodiment of the invention, a method for aggregating and visualizing reused shared lists can be provided.

The method can include selecting an existing shared list, determining a topic for the selected shared list, receiving list items by rank for the determined topic, generating a new shared list with the determined topic and received list items, and storing the new shared list in association with the existing shared list. The method further can include providing a reused shared list view for all reused shared lists for a common topic. Finally, the method can include aggregating all reused shared lists for a common topic either providing a view of the aggregation with list items for each rank for each reused shared list or providing a view of the aggregation with list items in rank order for all reused shared lists for the common topic.

In another embodiment of the invention, a social networking data processing system can be provided. The system can include a host server, a social network provided by the social networking data processing system executing in the host server and multiple different reused shared lists related to one another by common topic. The system further can include a reused shared list view of the reused shared lists. Finally, the system can include an aggregation view of the reused shared lists. The aggregation view can display list items for each rank for each of the reused shared lists or list items in rank order for the reused shared lists. For instance, a tag cloud view can be provided for the list items by rank in order to indicate a frequency of appearance of each list item by rank.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIGS. 1A through 1C, taken together, are a pictorial illustration of a user interface configured for aggregating and visualizing reused shared lists;

FIG. 2 is a schematic illustration of a social networking data processing system configured for aggregating and visualizing reused shared lists; and,

FIG. 3 is a flow chart illustrating a process for aggregating and visualizing reused shared lists.

### DETAILED DESCRIPTION OF THE INVENTION

Embodiments of the present invention provide a method, system and computer program product for aggregating and visualizing reused shared lists. In accordance with an embodiment of the present invention, an existing shared list of list items in rank order can be selected for reuse in response to which a new shared list can be created for the topic of the existing shared list. Each new shared list reusing an existing shared list can be linked both to a creator of the new shared list and also to the existing shared list such that a hierarchy of shared lists descending from a root shared list can be determined. Thereafter, the hierarchy of shared lists can be displayed in a view, each of the shared lists being represented in the view by a link to the creator, for instance by way of a thumbnail image of the creator, or to the list itself. Further, the shared lists can be aggregated to show a frequency of the list items for a specific topic, for instance by way of a tag cloud view of the choices.

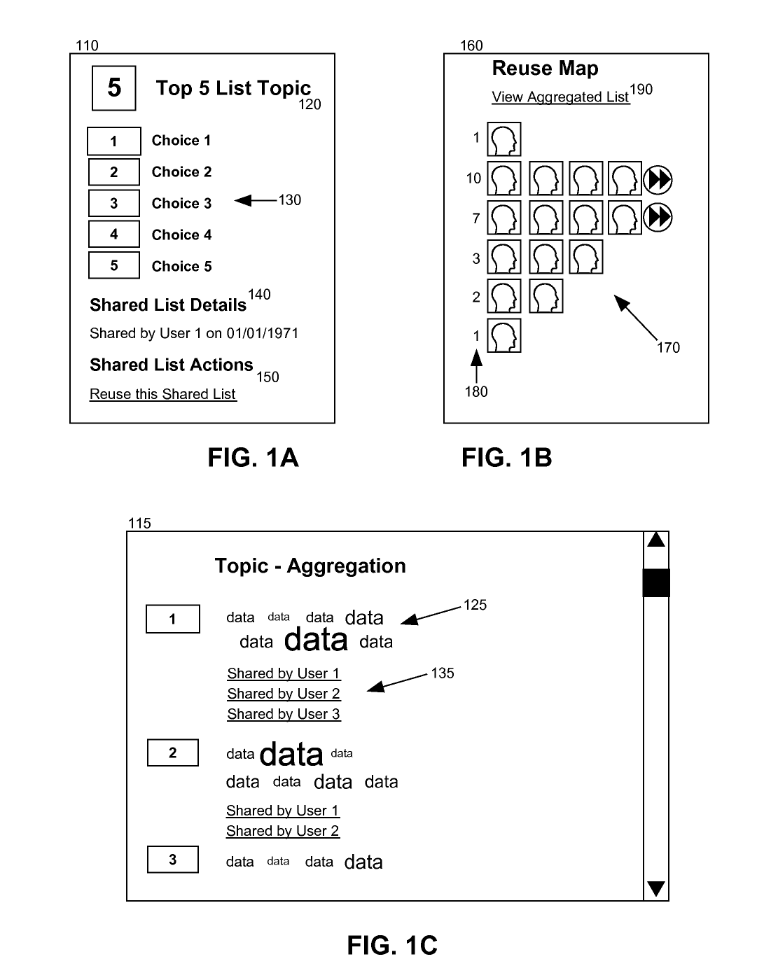

In further illustration, FIGS. 1A through 1C, taken together, are a pictorial illustration of a user interface configured for aggregating and visualizing reused shared lists. As shown in FIG. 1A, a shared list view 110 can be provided. The shared list view 110 can display an existing shared list including topic 120 and different list items 130 arranged in rank order. The shared list view 110 also can include a listing of shared list meta-data 140, such as the creator of the shared list. Notably, an activatable element 150 can be provided such that the activation of the activatable element 150 can result in the reuse of the existing shared list. Specifically, a user activating the activatable element 150 can be prompted to provide a set of new list items in rank order relating to the topic 120. Subsequently, the topic 120 and new list items (not shown) can be persisted in a new shared list associated with the user and the existing shared list. Optionally, the new shared list also can be associated with either or both of a root shared list for the existing shared list for ease of traversing a hierarchy of reused shared lists and also a generational indicator derived as the increment of the generational indicator for the existing shared list (the root shared list having a generational indicator of one).

Once a hierarchy of reused shared lists has been established, the hierarchy can be displayed within a reuse map. Specifically, referring to FIG. 1B, a reuse map view 160 can be provided to include a display of links 170 to different generations of reused shared lists. Each row of the display of links 170 can correspond to a different generation level of reused shared lists stemming from a root as will be apparent from FIG. 1B. Further, at each level an indication 180 of a number of shared lists in a given generation at a generational level can be provided and to the extent that the links 170 cannot be displayed within the limited display space of the reuse map view 160, an activatable indicator can be so provided as shown in FIG. 1B. It is to be understood, however, that other forms of display can be provided in lieu of the generational display of FIG. 1B, including a list view and a tree view to provide a more specific representation of a hierarchy of reused shared lists.

Notably, an activatable aggregated list element 190 can be disposed within the reuse map view 160. In response to the activation of the aggregated list element 190, a topical aggregation view 115 can be provided. The topical aggregation view 115 can include an aggregation of list items 125 for each rank for each instance of a reused shared list. Alternatively, the topical aggregation view 115 can include an aggregation of list items 125 in rank order for all instances of the reused shared lists. In either circumstance, the list items 125 can be rendered as a tag cloud in that a greater frequency of occurrence of a given one of the list items 125 can be rendered in a larger font as shown in FIG. 1C. Optionally, a listing of different users 135 contributing the list items 125 can be provided for each rank of the reused shared list.

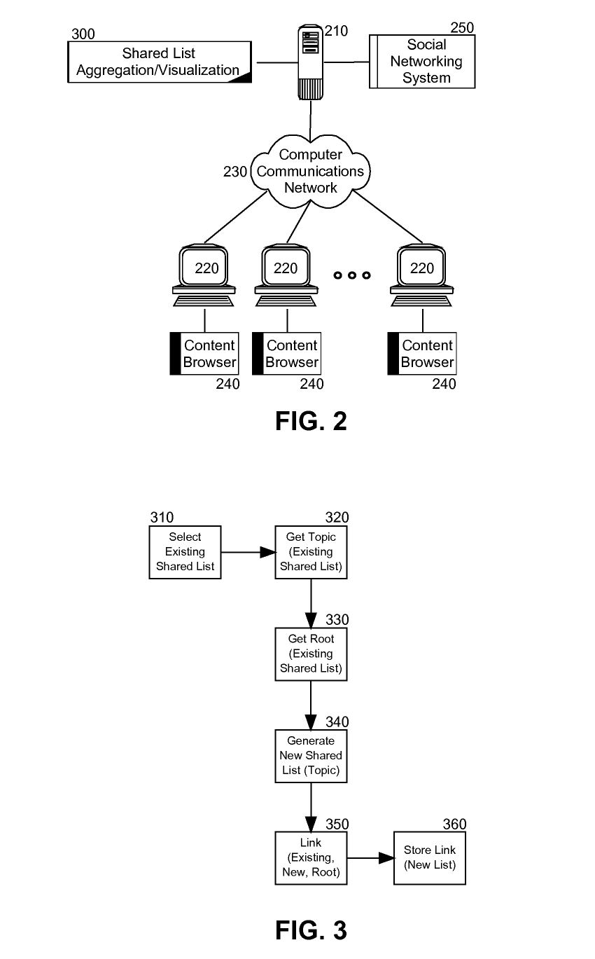

The user interface illustrated in FIGS. 1A through 1C can be generated within a social networking data processing system. In further illustration, FIG. 2 schematic depicts a social networking data processing system configured for aggregating and visualizing reused shared lists. The system can include a host server 210 communicatively coupled to multiple different clients 220 over computer communications network 230. The host server 210 can support the operation of a social networking system 250 configured to provide and manage a social network accessed by different users through respective content browsers 240 over computer communications network 230.

The social networking system 250 can support shared lists for users of the social network. In particular, the social networking system 250 can be coupled to reused shared list aggregation and visualization logic 300 including program code enabled to provide for the reuse, visualization and aggregation of shared lists produced by users of the social network. Specifically, the program code can be enabled to prompt an end user to provide a rank ordering of choices for a topic of a selected existing shared list. The resulting choices and the topic can be persisted in a reused shared list and associated with the existing shared list. Thereafter, a hierarchy of reused shared lists can be presented in a generational view or a tree view, to name two examples. Further, an aggregation of the reused shared lists for a common topic can be provided with each rank having a tag cloud presentation or in a single tag cloud across all ranks for the common topic.

In yet further illustration of the operation of the reused shared list aggregation and visualization logic 300, FIG. 3 is a flow chart illustrating a process for aggregating and visualizing reused shared lists. Beginning in block 310, an existing shared list can be selected for reuse by an end user. In block 320, a topic can be determined for the existing shared list and in block 330, a root shared list can be determined for the existing shared list (in addition to a generational level for the existing shared list). In block 340, a new shared list can be generated for the topic using new choices provided and ranked by the end user. Thereafter, in block 350 the new shared list can be linked to the existing shared list and the root shared list by storing a reference to both in the new shared list in block 360.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for shared list reuse, the method comprising:
selecting an existing shared list;
determining a topic for the selected shared list;
creating a new shared list with the determined topic;
receiving list items by rank for the determined topic and storing the list items by rank into the created new shared list; and,
storing the new shared list in association with the existing shared list.

2. The method of claim 1, further comprising providing a reused shared list view for all reused shared lists for a common topic.

3. The method of claim 2, wherein providing a reused shared list view for all reused shared lists for a common topic, comprises providing a generational view of a hierarchy of reused shared lists for a common topic.

4. The method of claim 3, wherein providing a reused shared list view for all reused shared lists for a common topic, comprises providing a tree view of a hierarchy of reused shared lists for a common topic.

5. The method of claim 1, further comprising:
aggregating all reused shared lists for a common topic; and,
providing a view of the aggregation with list items for each rank for each reused shared list.

6. The method of claim 1, further comprising:
aggregating all reused shared lists for a common topic; and,
providing a view of the aggregation with list items in rank order for all reused shared lists for the common topic.

7. The method of claim 6, wherein providing a view of the aggregation with list items for each rank for each reused shared list, comprises providing a tag cloud view of the aggregation with list items for each rank for each reused shared list.

8. The method of claim 7, wherein providing a view of the aggregation with list items in rank order for all reused shared lists for the common topic, comprises providing a tag cloud view of the aggregation with list items in rank order for all reused shared lists for the common topic.

9. A social networking data processing system comprising:
a host server;
a social network provided by the social networking data processing system executing in the host server;
a plurality of reused shared lists related to one another by common topic; and,
a reused shared list view of the reused shared lists.

10. The system of claim 9, further comprising an aggregation view of the reused shared lists, the aggregation view displaying list items for each rank for each of the reused shared lists.

11. The system of claim 9, further comprising an aggregation view of the reused shared lists, the aggregation view displaying list items in rank order for the reused shared lists.

12. A computer program product comprising a computer usable medium embodying computer usable program code for shared list reuse in a social networking environment, the computer program product comprising:
computer usable program code for selecting an existing shared list in a social network;
computer usable program code for determining a topic for the selected shared list;
computer usable program code for creating a new shared list with the determined topic;
computer usable program code for receiving list items by rank for the determined topic and storing the list items by rank into the created new shared list; and,
storing the new shared list in association with the existing shared list.

13. The computer program product of claim 12, further comprising computer usable program code for providing a reused shared list view for all reused shared lists for a common topic.

14. The computer program product of claim 13, wherein the computer usable program code for providing a reused shared list view for all reused shared lists for a common topic, comprises computer usable program code for providing a generational view of a hierarchy of reused shared lists for a common topic.

15. The computer program product of claim 14, wherein the computer usable program code for providing a reused shared list view for all reused shared lists for a common topic, comprises computer usable program code for providing a tree view of a hierarchy of reused shared lists for a common topic.

16. The computer program product of claim 12, further comprising:
computer usable program code for aggregating all reused shared lists for a common topic; and,
computer usable program code for providing a view of the aggregation with list items for each rank for each reused shared list.

17. The computer program product of claim 12, further comprising:
computer usable program code for aggregating all reused shared lists for a common topic; and,
computer usable program code for providing a view of the aggregation with list items in rank order for all reused shared lists for the common topic.

18. The computer program product of claim 16, wherein the computer usable program code for providing a view of the aggregation with list items for each rank for each reused shared list, comprises computer usable program code for providing a tag cloud view of the aggregation with list items for each rank for each reused shared list.

19. The computer program product of claim 17, wherein the computer usable program code for providing a view of the aggregation with list items in rank order for all reused shared lists for the common topic, comprises providing a tag cloud view of the aggregation with list items in rank order for all reused shared lists for the common topic.
